(19) United States
(12) Patent Application Publication
(10) Pub. No.: US 2026/0317197 A2
(43) Pub. Date: Oct. 15, 2026

(54) POSITIVE ELECTRODE ACTIVE MATERIAL, LITHIUM-ION SECONDARY BATTERY, AND MANUFACTURING METHOD FOR POSITIVE ELECTRODE ACTIVE MATERIAL

(71) Applicant: TOYOTA JIDOSHA KABUSHIKI KAISHA, Toyota-shi Aichi-ken (JP)

(72) Inventor: Issei Sugiyama, Susono-shi Shizuoka-ken (JP)

(73) Assignee: TOYOTA JIDOSHA KABUSHIKI KAISHA, Toyota-shi Aichi-ken (JP)

(21) Appl. No.: 18/142,846

(22) Filed: May 3, 2023

(30) Foreign Application Priority Data
May 9, 2022 (JP) 2022-077123

(51) Int. Cl. C01G 53/51; H01M 4/02; H01M 4/505; H01M 4/525

(52) U.S. Cl. CPC C01G 53/51; H01M 4/505; H01M 4/525; C01P 2002/72; C01P 2004/04; C01P 2004/82; C01P 2006/40; H01M 2004/028

(57) ABSTRACT

The present application discloses a positive electrode active material having cycle stability. The positive electrode active material of the present disclosure has an O2-type structure, includes at least Li, Na, at least one of Mn, Ni, and Co, and O as constituent elements, and has Na present in layer form.

### CROSS-REFERENCE TO RELATED APPLICATION

This application claims priority to Japanese Patent Application No. 2022-077123 filed on May 9, 2022, the entire contents of which are herein incorporated by reference.

### FIELD

The present application discloses a positive electrode active material, a lithium-ion secondary battery, and a manufacturing method for a positive electrode active material.

### BACKGROUND

Positive electrode active materials having an O2-type structure have been known. Positive electrode active materials having an O2-type structure are relatively stable even at high potential, and can thus utilize charging/discharging in a high potential range, and for example, can easily obtain high energy density. A positive electrode active material having an O2-type structure is obtained by replacing at least a portion of Na in a Na compound having a P2-type structure with Li. Specifically, as disclosed in PTL 1 and 2, a positive electrode active material having an O2-type structure is obtained by subjecting a Na compound having a P2-type structure to ion exchange using a lithium halide to replace at least a portion of Na with Li.

### CITATION LIST

### Patent Literature

[PTL 1] Japanese Unexamined Patent Publication No. 2021-068556
[PTL 2] Japanese Unexamined Patent Publication No. 2021-068555

### SUMMARY

### Technical Problem

There is a room left for improvement in terms of cycle stability of the conventional positive electrode active material having an O2-type structure.

### Solution to Problem

As a technique for solving the above problem, the present application discloses
a positive electrode active material having an O2-type structure, wherein
the positive electrode active material includes at least Li, Na, at least one of Mn, Ni, and Co, and O as constituent elements, and
the positive electrode active material has Na present in layer form.

The positive electrode active material of the present disclosure may have a composition represented by LiₐNa_{b}Mnₓ₋ₚNi_{y-q}Co_{z-r}M_{p+q+r}O₂, wherein 0<a≤1.00; 0.05≤b≤0.20; x+y+z=1; 0≤p+q+r≤0.15; and M is at least one element selected from B, Mg, Al, K, Ca, Ti, V, Cr, Fe, Cu, Zn, Ga, Ge, Sr, Y, Zr, Nb, Mo, and W.

As a technique for solving the above problem, the present application discloses
a lithium-ion secondary battery, comprising a positive electrode, an electrolyte layer, and a negative electrode, wherein
the positive electrode comprises the positive electrode active material of the present disclosure described above.

As a technique for solving the above problem, the present application discloses
a manufacturing method for a positive electrode active material, the method comprising:
obtaining a Na compound having a P2-type structure, and
replacing a portion of Na in the Na compound with Li by ion exchange, while allowing Na to remain in layer form, to obtain a Li compound having an O2-type structure.

In the manufacturing method of the present disclosure,
the Na compound may have a composition represented by Na_{c}Mnₓ₋ₚNi_{y-q}Co_{z-r}M_{p+q+r}O₂, wherein 0.70≤c≤1.00; x+y+z=1; 0≤p+q+r≤0.15; and M is at least one element selected from B, Mg, Al, K, Ca, Ti, V, Cr, Fe, Cu, Zn, Ga, Ge, Sr, Y, Zr, Nb, Mo, and W, and in the ion exchange, at least one of the following conditions (1) to (3) may be satisfied.

(1) A temperature of the ion exchange is 350° C. or higher.

(2) A mixture of a lithium halide (A) and a lithium compound (B) other than a lithium halide is used in the ion exchange, and a mass ratio (A/B) of the lithium halide (A) to the lithium compound (B) of the mixture is 0.25 or greater.

(3) At least one of LiBr and LiI is used in the ion exchange.

### [Effects]

The positive electrode active material of the present disclosure has cycle stability.

### BRIEF DESCRIPTION OF DRAWINGS

FIG. 1 shows an example of a HAADF-STEM image of the positive electrode active material of the present disclosure and a Na composition mapping corresponding to the HAADF-STEM image.

FIG. 2A is a graph for describing a method for verifying that “Na is present in layer form”.

FIG. 2B is a graph for describing a method for verifying that “Na is present in layer form”.

FIG. 3 schematically shows an example of a configuration of a lithium-ion secondary battery.

FIG. 4 schematically shows states before and after ion exchange during which a lattice shift occurs.

FIG. 5 schematically shows that a large number of nuclei are generated during ion exchange and grow to form mismatched regions.

FIG. 6 shows X-ray diffraction peaks of each of the positive electrode active materials according to Examples 1 and 2 and Comparative Examples 1 and 2.

FIG. 7 shows cycle characteristics of each of the coin cells according to Examples 1 and 2 and Comparative Examples 1 and 2.

FIG. 8 shows a HAADF-STEM image of a surface of each of the positive electrode active materials according to Example 1 and Comparative Example 2 and a Na composition mapping corresponding to each of the HAADF-STEM images.

### DESCRIPTION OF EMBODIMENTS

### 1. Positive Electrode Active Material

The positive electrode active material of the present disclosure has an O2-type structure, includes at least Li, Na, at least one of Mn, Ni, and Co, and O as constituent elements, and has Na present in layer form.

### 1.1 Crystal Structure

The positive electrode active material of the present disclosure comprises at least an O2-type structure (belonging to space group P63mc) as a crystal structure. The positive electrode active material of the present disclosure may have a crystal structure other than the O2-type structure, in addition to having the O2-type structure. Examples of the crystal structure other than the O2-type structure include a T #2-type structure (belonging to space group Cmca) and an O6-type structure (belonging to space group R-3m, which has a c-axis length of 2.5 nm or more and 3.5 nm or less, typically 2.9 nm or more and 3.0 nm or less, and differs from the O3-type structure belonging to the same space group R-3m) formed through Li deintercalation from the O2-type structure. The positive electrode active material of the present disclosure may have the O2-type structure as the main phase or a crystal structure other than the O2-type structure as the main phase. In the positive electrode active material of the present disclosure, the crystal structure as the main phase can change depending on the charging/discharging state.

### 1.2 Composition

The positive electrode active material of the present disclosure includes at least Li, Na, at least one of Mn, Ni, and Co, and O as constituent elements. Specifically, when at least Li, Na, Mn, at least one of Ni, and Co, and O are included as constituent elements, in particular, when at least Li, Na, Mn, Ni, Co, and O are included as constituent elements, the performance of the positive electrode active material of the present disclosure is likely to be higher. In the positive electrode active material of the present disclosure, the amount of Li present may reach near zero because, for example, Li is released by charging.

The positive electrode active material of the present disclosure may have a composition represented by LiₐNa_{b}Mnₓ₋ₚNi_{y-q}Co_{z-r}M_{p+q+r}O₂, wherein 0<a≤1.00; 0.05≤b≤0.20; x+y+z=1; and 0≤p+q+r≤0.15. In addition, M is at least one element selected from B, Mg, Al, K, Ca, Ti, V, Cr, Fe, Cu, Zn, Ga, Ge, Sr, Y, Zr, Nb, Mo, and W. When the positive electrode active material has such a composition, the O2-type structure is easily maintained, a sufficient amount of Na is likely to be present in layer form, and the crystal structure is more easily stabilized.

In the above composition, “a” may be greater than 0, 0.10 or greater, 0.20 or greater, 0.30 or greater, 0.40 or greater, 0.50 or greater, or 0.60 or greater, and may be 1.00 or less, 0.90 or less, 0.80 or less, or 0.70 or less. In the above composition, “b” may be 0.05 or greater, 0.06 or greater, 0.07 or greater, or 0.08 or greater, and may be 0.20 or less, 0.15 or less, or 0.10 or less. In the above composition, “x” may be 0 or greater, 0.10 or greater, 0.20 or greater, 0.30 or greater, 0.40 or greater, or 0.50 or greater, and may be 1.00 or less, 0.90 or less, 0.80 or less, 0.70 or less, 0.60 or less, or 0.50 or less. In the above composition, “y” may be 0 or greater, 0.10 or greater, or 0.20 or greater, and may be 1.00 or less, 0.90 or less, 0.80 or less, 0.70 or less, 0.60 or less, 0.50 or less, 0.40 or less, 0.30 or less, or 0.20 or less. In the above composition, “z” may be 0 or greater, 0.10 or greater, 0.20 or greater, or 0.30 or greater, and may be 1.00 or less, 0.90 or less, 0.80 or less, 0.70 or less, 0.60 or less, 0.50 or less, 0.40 or less, or 0.30 or less. Many elements of M do not contribute to charging/discharging. In this regard, when “p+q+r” is 0.15 or less, a high charging/discharging capacity is easily ensured. The “p+q+r” may be 0.10 or less, or may be 0. The composition of O is mostly 2, but is not limited to exactly 2.0 and may vary.

In the above composition, when “b” is 0.05 or greater, it is considered that a Na residual phase (structure-stabilizing phase) having a Na content ratio of 50% can be present in at least one out of 10 layers. The range in which structural deterioration due to introduction of a dislocation (a partial dislocation must cross grains during stacking fault formation) can be suppressed by a stabilized structure can be estimated from the strain field formed around the dislocation. In the case of an edge dislocation whose Burgers vector is parallel to the c-axis and is half the length of the c-axis (corresponding to one layer of a layered structure), and in the case of an oxide material, a strain field of at least 5% or greater is formed in the range of 5 layers from the dislocation. If a structure-stabilizing heterogeneous phase is present at a position where a strain field of 5% is formed, a nearly 5% lattice mismatch is formed. Since it is considered that a dislocation is introduced when a lattice mismatch of 5% is formed, assuming that the dislocation is introduced first, the dislocation forms more dislocations and multiplies infinitely. Therefore, it is considered that if a structure-stabilizing phase is present in one out of 10 layers, a structure-stabilizing effect extends to the entire positive electrode active material. In this regard, when “b” is 0.05 or greater, a structure-stabilizing effect can be expected. However, if “b” is too large, the charging/discharging capacity may be decreased. When “b” is 0.20 or less, a sufficient capacity is easily ensured.

In the above composition, when the valence of M is +n, a relation of 3.0≤4(x−p)+2(y−q)+3(z−r)+n(p+q+r)≤3.4 may be satisfied. This is intended for a range in which the total valence of metals in the positive electrode active material is near 3.33 (charge neutrality when “a” is 0.67). As will be described below, the positive electrode active material having an O2-type structure is synthesized via a Na compound having a P2-type structure, and at this time, in the range in which the Na composition is 0.6 or greater and 1.0 or less, being neutral in charge corresponds to satisfying the above relation. The details of the composition of the Na compound having a P2-type structure will be described below.

The composition of the positive electrode active material can be determined by, for example, inductively coupled plasma atomic emission spectroscopy (ICP-AES).

### 1.3 Na in Layer Form

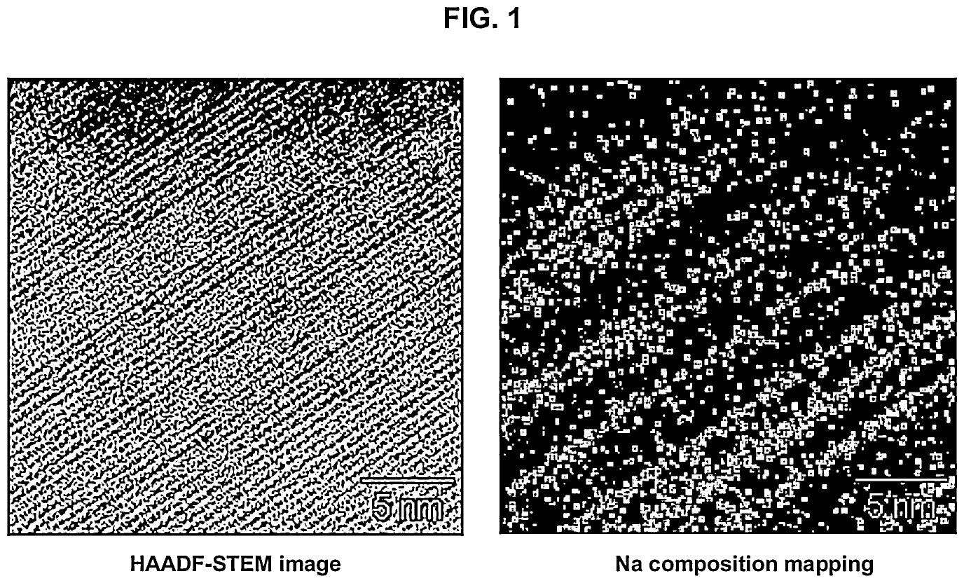

In the positive electrode active material of the present disclosure, Na is present in layer form. FIG. 1 shows an example of a HAADF-STEM image of the positive electrode active material of the present disclosure and a Na composition mapping corresponding to the HAADF-STEM image. As shown in the HAADF-STEM image and Na composition mapping in FIG. 1, in the positive electrode active material of the present disclosure, when STEM-EDXS measurement is carried out in an electron beam incident direction [hk0] (h and k are each 0 or any positive integer), a region where Na is present at a high concentration extends in one direction, a plurality of the regions are present, and intervals above a certain level are present between the plurality of regions. The positive electrode active material of the present disclosure has a plurality of layered alkali metal sites in a predetermined plane of the crystal structure, and while Na is present at a high concentration at one layered site, a large amount of Na is replaced with Li at another layered site. In other words, it can be said that the portions where a high concentration of Na is present and the portions where Na is replaced with Li in the positive electrode active material are nonuniform, and due to this nonuniformity, the Na in layer form is observed in the Na composition mapping. Whether or not Na is present in layer form in the positive electrode active material is determined from the HAADF-STEM image of the positive electrode active material and the corresponding composition mapping by the following method.

(1) A HAADF-STEM image in which the electron beam incident direction is any of <100>, <010>, and <110> under the condition that the electron beam probe diameter is 0.1 nm or less, and a composition mapping corresponding to the image are acquired with respect to the positive electrode active material. The composition mapping is obtained by partitioning a 25 nm×25 nm region in the HAADF-STEM image into 512 by 512 areas and then obtaining the composition of each area by STEM-EDXS. For the STEM-EDX measurement, an apparatus configuration of an X-ray detection solid angle of 1 str or more is used. The phase electron beam dose for the entire observation area is set to 1.5×10\hat{ }14 e or less, and measurement is carried out under the conditions of an electron beam scan rate of 0.15 frames/s or more and a measurement time of 10 min or more. In addition, during measurement, for any 30s section extracted, a drift correction is applied so that the amount of sample movement in the section is 0.1 nm or less. In the composition mapping, only Mn, Ni, Co, M, and Na are defined as existing elements, and the presence of each existing element is indicated by atom %. In the composition mapping, spectra relating to the amounts of Mn, Ni, Co, M, and Na present for each area are obtained. The ratio of Na when the amounts of Mn, Ni, Co, M, and Na total to 100 atom % is defined as “Na composition”.

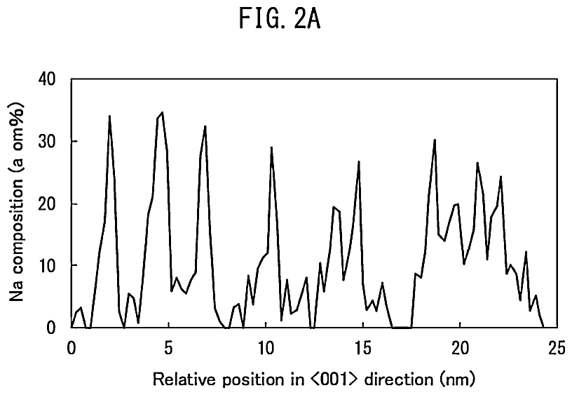

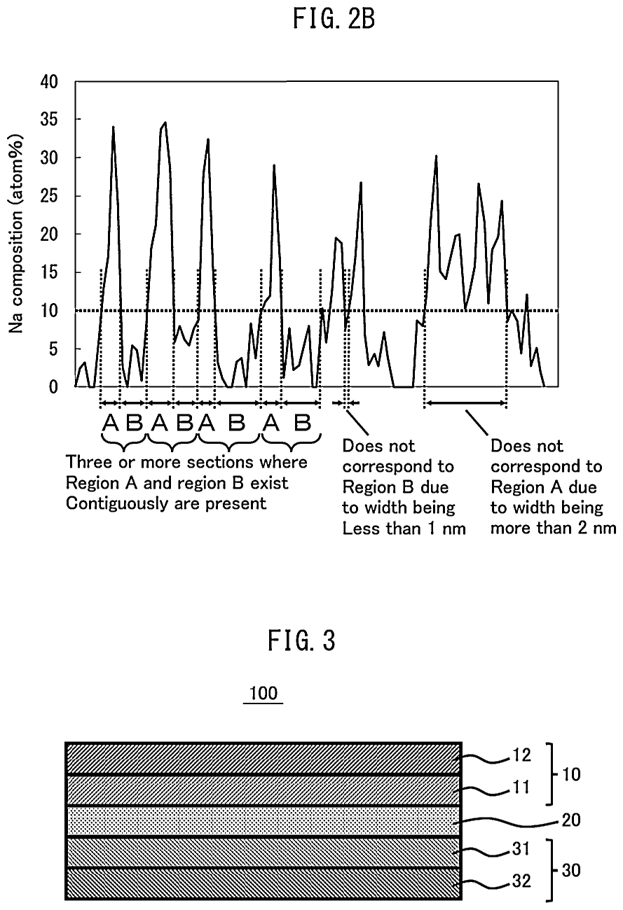

(2) Of the partitioned 512 by 512 areas, for 50 or more connecting areas (“contiguous areas”) in the direction perpendicular to <001> in the STEM image, the above spectra are integrated and the Na compositions (atom %) in the contiguous areas are specified. As such, the Na compositions (atom %) in the contiguous areas perpendicular to <001> are sequentially determined in the direction (“width direction”) of <001> to obtain a graph plotting the relationship between Na compositions (atom %) and relative positions (nm) in the width direction. As an example, a graph as in FIG. 2A is obtained.

(3) In the resulting graph, a section having contiguous areas where the atom % of Na is 10% or greater and the width is 2 nm or less is defined as “region A”. In addition, a section having contiguous areas where the atom % of Na is less than 10% and the width is 1 nm or more is defined as “region B”. For example, when regions A and B are specified in the graph shown in FIG. 2A, the graph is shown as in FIG. 2B.

(4) In the resulting graph, “region A” and “region B” are specified as described above, and whether or not “region A” and “region B” exist contiguously is determined. If HAADF-STEM images having three or more sections where “region A” and “region B” exist contiguously (there are three or more sections of the contiguous arrangement of region A and region B in a single field of view) are obtained in three or more fields of view for the positive electrode active material, it is considered that “Na is present in layer form” in the positive electrode active material. The expressions “section where region A and region B exist contiguously” and “contiguous arrangement of region A and region B” refer to a combination of one region A and one region B adjacent each other, as shown in FIG. 2B. In FIG. 2B, three or more of the combinations are adjacent each other (contiguous). However, the combinations may be separated from each other, i.e., there may be a region which does not correspond to either region A or region B between one combination and another combination.

In the positive electrode active material of the present disclosure, the width of “region A” analyzed and measured as described above may be 0.3 nm or more or 0.5 nm or more, and may be 1.8 nm or less or 1.5 nm or less. The width of “region B” measured as described above may be 1.5 nm or more or 2.0 nm or more, and may be 100 nm or less or 10 nm or less.

When a conventional positive electrode active material having an O2-type structure is charged to a high potential of about 4.8 V, the crystal structure may be destabilized due to deintercalation of Li. Further, migration of transition metal to the Li sites and formation of stacking faults caused by the destabilization of the crystal structure may occur, leading to capacity degradation. As a method for solving such problems, a phase stable at high potential can be formed in a portion within the crystal structure, whereby the phase can be used as a pinning phase. According to new findings of the present inventor, in the positive electrode active material of the present disclosure, Na present in layer form within the crystal structure is very stable and unlikely to be deintercalated in the course of charging and discharging, and can act as a pinning phase for the bulk O2-type structure. That is, when Na is present in layer form in the positive electrode active material having an O2-type structure, it is considered that a desired crystal structure is easily maintained even when charging is carried out at a high potential and the amount of Li within the crystal structure is decreased, whereby capacity degradation is easily suppressed, and cycle stability is easily obtained.

### 1.4 Shape

Any general shape for a positive electrode active material for batteries may be used as the shape of the positive electrode active material of the present disclosure. For example, the positive electrode active material of the present disclosure may be particulate. The particles of the positive electrode active material may be solid particles or hollow particles, or may have voids. The particles of the positive electrode active material may be primary particles, or may be secondary particles of a plurality of agglomerated primary particles. The average particle diameter (D50) of the positive electrode active material may be, for example, 1 nm or more, 5 nm or more, or 10 nm or more, and may be 500 μm or less, 100 μm or less, 50 μm or less, or 30 μm or less. Note that, the average particle diameter D50 as described herein is a particle diameter (median diameter) at an integrated value of 50% in a volume-based particle size distribution determined by a laser diffraction or scattering method.

### 1.5 Supplementary

As described above, Na is present in layer form in the positive electrode active material having an O2-type structure, whereby the stabilizing effect on the crystal structure is remarkable. Even in a positive electrode active material having an O2-type structure and a large amount of Na, the stabilizing effect on the crystal structure due to the sufficient presence of Na can be exhibited. In this regard, the present application discloses another embodiment of the positive electrode active material, having an O2-type structure and having a composition represented by LiₐNa_{b}Mₓ₋ₚNi_{y-q}Co_{z-r}M_{p+q+r}O₂, wherein 0<a≤1.00; 0.05≤b≤0.20; x+y+z=1; 0≤p+q+r≤0.15; and M is at least one element selected from B, Mg, Al, K, Ca, Ti, V, Cr, Fe, Cu, Zn, Ga, Ge, Sr, Y, Zr, Nb, Mo, and W. The details of “a”, “b”, “x”, “y”, “z”, “p”, “q”, and “r” are as described above.

### 2. Positive Electrode

The technique of the present disclosure also has an aspect as a positive electrode comprising the above positive electrode active material. Specifically, the positive electrode of the present disclosure comprises a positive electrode active material which has an O2-type structure, includes at least Li, Na, at least one of Mn, Ni, and Co, and O as constituent elements, and has Na present in layer form. As shown in FIG. 3, a positive electrode 10 according to one embodiment may comprise a positive electrode active material layer 11 and a positive electrode current collector 12. In that case, the positive electrode active material layer 11 may comprise the above positive electrode active material having an O2-type structure.

### 2.1 Positive Electrode Active Material Layer

The positive electrode active material layer 11 comprises at least the above positive electrode active material of the present disclosure, and may further optionally comprise an electrolyte, a conductive aid, and a binder. The positive electrode active material layer 11 may additionally comprise various additives. The content of each of the positive electrode active material, the electrolyte, the conductive aid, and the binder of the positive electrode active material layer 11 may be appropriately determined according to the target performance. For example, when the entire positive electrode active material layer 11 (total solid content) is 100% by mass, the content of the positive electrode active material may be 40% by mass or greater, 50% by mass or greater, or 60% by mass or greater, and may be 100% by mass or less or 90% by mass or less. The shape of the positive electrode active material layer 11 is not particularly limited, and may be, for example, a sheet-like positive electrode active material layer 11 having a substantially flat surface. The thickness of the positive electrode active material layer 11 is not particularly limited, and may be, for example, 0.1 μm or more or 1 μm or more, and may be 2 mm or less or 1 mm or less.

### 2.1.1 Positive Electrode Active Material

The positive electrode active material layer 11 may comprise only the above positive electrode active material of the present disclosure, as a positive active material. Alternatively, the positive electrode active material layer 11 may comprise a positive electrode active material (another positive electrode active material) different from the above positive electrode active material of the present disclosure in addition thereto. From the viewpoint of further enhancing the effect due to the technique of the present disclosure, the positive electrode active material layer 11 may contain therein a small amount of another positive electrode active material. For example, when all of the positive electrode active material contained in the positive electrode active material layer 11 is 100% by mass, the content of the above positive electrode active material of the present disclosure may be 50% by mass or greater, 60% by mass or greater, 70% by mass or greater, 80% by mass or greater, 90% by mass or greater, 95% by mass or greater, or 99% by mass or greater.

The surface of the positive electrode active material may be covered with a protective layer containing a lithium-ion conductive oxide. That is, the positive electrode active material layer 11 may include a composite comprising the above positive electrode active material and a protective layer provided on the surface thereof. As a result, a reaction between the positive electrode active material and a sulfide (for example, a sulfide solid electrolyte described below) can be easily suppressed. Examples of the lithium-ion conductive oxide include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, and Li₂WO₄. The coverage (area ratio) of the protective layer may be, for example, 70% or greater, 80% or greater, or 90% or greater. The thickness of the protective layer, may be, for example, 0.1 nm or more or 1 nm or more, or may be 100 nm or less or 20 nm or less.

### 2.1.2 Electrolyte

The electrolyte that may be contained in the positive electrode active material layer 11 may be a solid electrolyte, a liquid electrolyte (electrolytic solution), or a combination thereof.

Any solid electrolyte publicly known as a solid electrolyte for lithium-ion secondary batteries may be used. The solid electrolyte may be an inorganic solid electrolyte or an organic polymer electrolyte. Particularly, the inorganic solid electrolyte has ion conductive properties and heat resistance. Examples of the inorganic solid electrolyte may include oxide solid electrolytes such as lithium lanthanum zirconate, LiPON, Li_{1+X}Al_{X}Ge_{2-X}(PO₄)₃, Li—SiO-based glass, and Li—Al—S—O-based glass; and sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂. Particularly, sulfide solid electrolytes, more particularly, sulfide solid electrolytes comprising at least Li, S, and P as constituent elements have high performance. The solid electrolyte may be amorphous or crystalline. The solid electrolyte may be, for example, particulate. One type of solid electrolyte may be used alone, or two or more types may be used in combination.

The electrolytic solution may comprise, for example, lithium ions as carrier ions. The electrolytic solution may be an aqueous electrolytic solution or a nonaqueous electrolytic solution. The composition of the electrolytic solution composition may be the same as that publicly known as a composition of an electrolytic solution for lithium-ion secondary batteries. For example, an electrolytic solution in which a predetermined concentration of lithium salt dissolved in a carbonate-based solvent may be used. Examples of the carbonate-based solvent include fluoroethylene carbonate (FEC), ethylene carbonate (EC), and dimethyl carbonate (DMC). Examples of the lithium salt include LiPF₆.

### 2.1.3 Conductive Aid

Examples of the conductive aid that may be contained in the positive electrode active material layer 11 include carbon materials such as vapor-grown carbon fiber (VGCF), acetylene black (AB), Ketjen black (KB), carbon nanotube (CNT), and carbon nanofiber (CNF); and metal materials such as nickel, aluminum, and stainless steel. The conductive aid may be, for example, particulate or fibrous, and the size thereof is not particularly limited. One type of conductive aid may be used alone, or two or more types may be used in combination.

### 2.1.4 Binder

Examples of the binder that may be contained in the positive electrode active material layer 11 include butadiene rubber (BR)-based binders, butylene rubber (IIR)-based binders, acrylate-butadiene rubber (ABR)-based binders, styrene-butadiene (SBR)-based binders, polyvinylidene fluoride (PVdF)-based binders, polytetrafluoroethylene (PTFE)-based binders, and polyimide (PI)-based binders. One type of binder may be used alone, or two or more types may be used in combination.

### 2.2 Positive Electrode Current Collector

As shown in FIG. 3, the positive electrode 10 may comprise a positive electrode current collector 12 in contact with the above positive electrode active material layer 11. Any general positive electrode current collector for batteries can be adopted as the positive electrode current collector 12. The positive electrode current collector 12 may be a foil, a plate, a mesh, a punched metal, or a foam. The positive electrode current collector 12 may be composed of a metal foil or a metal mesh. Particularly, a metal foil has handleability. The positive electrode current collector 12 may be formed of a plurality of foils. Examples of the metal constituting the positive electrode current collector 12 include Cu, Ni, Cr, Au, Pt, Ag, Al, Fe, Ti, Zn, Co, and stainless steel. Particularly, from the viewpoint of ensuring oxidation resistance, the positive electrode current collector 12 may comprise Al. The positive electrode current collector 12 may have on the surface thereof some coating layer for the purpose such as adjusting resistance. The positive electrode current collector 12 may be a metal foil or a substrate plated or vapor-deposited with the above metal. When the positive electrode current collector 12 is made of a plurality of metal foils, there may be some layer between the plurality of metal foils. The thickness of the positive electrode current collector 12 is not particularly limited, and may be, for example, 0.1 μm or more or 1 μm or more, and may be 1 mm or less or 100 μm or less.

### 2.3 Others

The positive electrode 10 may have any general configuration for a positive electrode for secondary batteries, in addition to the above configuration. For example, the positive electrode may have a tab or a terminal. The positive electrode 10 may be manufactured by any publicly known method as long as a positive electrode active material having an O2-type structure described above is used as the positive electrode active material. For example, the positive electrode active material layer 11 can be easily formed by dry or wet molding of a positive electrode mixture comprising the various components described above. The positive electrode active material layer 11 may be molded together with the positive electrode current collector 12, or may be molded separately from the positive electrode current collector 12.

### 3. Lithium-Ion Secondary Battery

As shown in FIG. 3, a lithium-ion secondary battery 100 according to one embodiment comprises a positive electrode 10, an electrolyte layer 20, and a negative electrode 30. The positive electrode 10 comprises the above positive electrode active material of the present disclosure. As described above, the positive electrode active material of the present disclosure has structure stability even at high potential. In this regard, by including the positive electrode active material of the present disclosure in the positive electrode of the lithium-ion secondary battery 100, the cycle characteristics of the secondary battery 100 are easily enhanced. Examples of specific configurations of the positive electrode 10 are as described above.

### 3.1 Electrolyte Layer

The electrolyte layer 20 comprises at least an electrolyte. When the lithium-ion secondary battery 100 is a solid-state battery (may be a battery comprising a solid electrolyte partly used in combination with a liquid electrolyte, or may be an all-solid-state battery free of a liquid electrolyte), the electrolyte layer 20 comprises a solid electrolyte and may further optionally comprise a binder. In this case, the contents of the solid electrolyte and the binder in the electrolyte layer 20 are not particularly limited. When the lithium-ion secondary battery 100 is an electrolytic solution battery, the electrolyte layer 20 comprises an electrolytic solution, and may further comprise a separator for retaining the electrolytic solution and preventing contact between the positive electrode active material layer 11 and the negative electrode active material layer 31. The thickness of the electrolyte layer 20 is not particularly limited, and may be, for example, 0.1 μm or more or 1 μm or more, and may be 2 mm or less or 1 mm or less.

The electrolyte contained in the electrolyte layer 20 may be appropriately selected from those exemplified as electrolytes that may be contained in the positive electrode active material layer described above. The binder that can be contained in the electrolyte layer 20 may also be appropriately selected from those exemplified as binders that may be contained in the positive electrode active material layer described above. For each of the electrolyte and the binder, one type thereof may be used alone, or two or more types thereof may be used in combination. Any separator normally used in lithium-ion secondary batteries may be used. Examples thereof include those made of resins such as polyethylene (PE), polypropylene (PP), polyesters, and polyamides. The separator may be of a single-layer structure or a multilayer structure. Examples of the separator having a multilayer structure can include separators having a two-layer structure of PE/PP and separators having a three-layer structure of PP/PE/PP or PE/PP/PE. The separator may be made of a nonwoven fabric such as a cellulose nonwoven fabric, a resin nonwoven fabric, or a glass fiber nonwoven fabric.

### 3.2 Negative Electrode

As shown in FIG. 3, the negative electrode 30 may comprise a negative electrode active material layer 31 and a negative electrode current collector 32.

### 3.2.1 Negative Electrode Active Material Layer

The negative electrode active material layer 31 comprises at least a negative electrode active material, and may further optionally comprise an electrolyte, a conductive aid, and a binder. The negative electrode active material layer 31 may additionally comprise various additives. The content of each of the negative electrode active material, the electrolyte, the conductive aid, and the binder in the negative electrode active material layer 31 may be appropriately determined according to the target performance. For example, when the entire negative electrode active material layer 31 (total solid content) is 100% by mass, the content of the negative electrode active material may be 40% by mass or greater, 50% by mass or greater, or 60% by mass or greater, and may be 100% by mass or less or 90% by mass or less. The shape of the negative electrode active material layer 31 is not particularly limited, and may be, for example, a sheet-like negative electrode active material layer having a substantially flat surface. The thickness of the negative electrode active material layer 31 is not particularly limited, and may be, for example, 0.1 μm or more or 1 μm or more, and may be 2 mm or less or 1 mm or less.

Various materials having a potential (charge/discharge potential) at which lithium ions are stored and released that is more electronegative than that of the above positive electrode active material of the present disclosure can be adopted as the negative electrode active material. For example, silicon-based active materials such as Si, Si alloys, and silicon oxides; carbon-based active materials such as graphite and hard carbon; various oxide-based active materials such as lithium titanate; and metallic lithium and lithium alloys can be adopted. One type of negative electrode active material may be used alone, or two or more types thereof may be used in combination.

Any general shape for a negative electrode active material for batteries may be used as the shape of the negative electrode active material. For example, the negative electrode active material may be particulate. The negative electrode active material particles may be primary particles, or may be secondary particles of a plurality of agglomerated primary particles. The average particle diameter (D50) of the negative electrode active material particles may be, for example, 1 nm or more, 5 nm or more, or 10 nm or more, and may be 500 μm or less, 100 μm or less, 50 μm or less, or 30 μm or less. Alternatively, the negative electrode active material may be sheet-like (foil-like or membranous), such as a lithium foil. Specifically, the negative electrode active material layer 31 may be made of a sheet of a negative electrode active material.

Examples of the electrolyte that may be contained in the negative electrode active material layer 31 include the solid electrolytes described above, liquid electrolytes, and combinations thereof. Examples of the conductive aid that may be contained in the negative electrode active material layer 31 include the carbon materials and the metal materials described above. The binder that may be contained in the negative electrode active material layer 31 may be appropriately selected from, for example, binders exemplified as a binder that may be contained in the above positive electrode active material layer 11. For each of the electrolyte and the binder, one type thereof may be used alone, or two or more types thereof may be used in combination.

### 3.2.2 Negative Electrode Current Collector

As shown in FIG. 3, the negative electrode 30 may comprise a negative electrode current collector 32 in contact with the above negative electrode active material layer 31. Any general negative electrode current collector for batteries can be adopted as the negative electrode current collector 32. The negative electrode current collector 32 may be a foil, a plate, a mesh, a punched metal, or a foam. The negative electrode current collector 32 may be a metal foil or a metal mesh, or may be a carbon sheet. Particularly, a metal foil has handleability. The negative electrode current collector 32 may be formed of a plurality of foils or sheets. Examples of the metal constituting the negative electrode current collector 32 include Cu, Ni, Cr, Au, Pt, Ag, Al, Fe, Ti, Zn, Co, and stainless steel. Particularly, from the viewpoints of ensuring reduction resistance and making alloying with lithium difficult, the negative electrode current collector 32 may comprise at least one metal selected from Cu, Ni, and stainless steel. The negative electrode current collector 32 may have on the surface thereof some coating layer for the purpose of adjusting resistance. The negative electrode current collector 32 may be a metal foil or a substrate plated or vapor-deposited with the above metal. When the negative electrode current collector 32 is made of a plurality of metal foils, there may be some layer between the plurality of metal foils. The thickness of the negative electrode current collector 32 is not particularly limited, and may be, for example, 0.1 μm or more or 1 μm or more, and may be 1 mm or less or 100 μm or less.

### 3.3 Additional Features

In the lithium-ion secondary battery 100, each of the above components may be housed inside an outer packaging. Any known outer packaging for batteries can be adopted as the outer packaging. In addition, a plurality of batteries 100 may be optionally electrically connected and optionally stacked to form a battery pack. In this case, the battery pack may be housed inside a known battery case. The lithium-ion secondary battery 100 may additionally comprise obvious components such as the necessary terminals. Examples of the shape of the lithium-ion secondary battery 100 may include a coin, a laminate, a cylinder, and a rectangle.

The lithium-ion secondary battery 100 can be manufactured by applying a known method, for example, the following method. However, the manufacturing method for the lithium-ion secondary battery 100 is not limited to the following method, and each layer may be formed by, for example, dry molding.

(1) A negative electrode active material and etc. constituting a negative electrode active material layer are dispersed in a solvent to obtain a negative electrode layer slurry. The solvent used in this case is not particularly limited. Water and various organic solvents can be used, and the solvent may be N-methylpyrrolidone (NMP). The negative electrode layer slurry is applied to a surface of a negative electrode current collector using a doctor blade and then dried to form a negative electrode active material layer on the surface of the negative electrode current collector to obtain a negative electrode.
(2) A positive electrode active material and etc. constituting a positive electrode active material layer are dispersed in a solvent to obtain a positive electrode layer slurry. The solvent used in this case is not particularly limited. Water and various organic solvents can be used, and the solvent may be N-methylpyrrolidone (NMP). The positive electrode layer slurry is applied to a surface of a positive electrode current collector using a doctor blade and then dried to form a positive electrode active material layer on the surface of the positive electrode current collector to obtain a positive electrode.
(3) The layers are laminated such that an electrolyte layer (solid electrolyte layer or separator) is interposed between the negative electrode and the positive electrode, in the order of negative electrode current collector, negative electrode active material layer, electrolyte layer, positive electrode active material layer, and positive electrode current collector, to obtain a laminated body. Additional members such as terminals are attached to the laminated body as needed.
(4) The laminated body is housed in a battery case. In the case of an electrolytic solution battery, the battery case is filled with an electrolytic solution, the laminated body is immersed in the electrolytic solution, and the laminated body is sealed in the battery case to obtain a secondary battery. In the case of an electrolytic solution battery, the electrolytic solution may be included in the negative electrode active material layer, the separator, and the positive electrode active material layer in the above step (3).

### 4. Manufacturing Method for Positive Electrode Active Material

The positive electrode active material of the present disclosure can be manufactured, for example, by the following method. Specifically, the manufacturing method for the positive electrode active material of the present disclosure comprises
obtaining a Na compound having a P2-type structure, and
replacing a portion of Na in the Na compound with Li by ion exchange, while allowing Na to remain in layer form, to obtain a Li compound having an O2-type structure.

### 4.1 Synthesis of Na Compound Having P2-Type Structure

Since the O2-type structure is a metastable phase, it is necessary to first synthesize a Na compound having a P2-type structure, which has a similar structure thereto, and then carry out ion exchange on at least a portion of Na in the Na compound with Li to obtain the O2-type structure. Therefore, in the manufacturing method of the present disclosure, a Na compound having a P2-type structure is first obtained. The Na compound having a P2-type structure can be synthesized by a known method. For example, a precipitate derived from a source of ions capable of forming the precipitate with transition metal ions in an aqueous solution and a transition metal source is mixed with a Na source to obtain a mixture, the mixture is optionally molded and pre-fired and is then subjected to main firing, whereby the Na compound having a P2-type structure can be synthesized.

Examples of the source of ions capable of forming a precipitate with transition metal ions include salts such as carbonates and nitrates, sodium hydroxide, and sodium oxide. Examples of the transition metal source include salts such as nitrates, sulfates, and carbonates and hydroxides. The ion source and the transition metal source may be made into respective solutions, and the respective solutions may be added dropwise or mixed to obtain a precipitate. In this case, various sodium compounds may be used as the base, and an aqueous ammonia solution may be added to adjust basicity. The amount of the Na source to be mixed before firing the precipitate may be determined considering the amount of Na lost during firing. Examples of the Na source include sodium carbonate, sodium oxide, sodium nitrate, and sodium hydroxide. Pre-firing is carried out at a temperature below or equal to that of a main firing. The pre-firing may be omitted. The main firing may be carried out at, for example, 700° C. or higher and 1100° C. or lower, or at 800° C. or higher and 1000° C. or lower. When the firing temperature is too low, Na doping does not occur. When the firing temperature is too high, an O3-type structure is likely to be generated instead of a P2-type structure. The firing atmosphere is not particularly limited, and may be, for example, an oxygen-containing atmosphere, such as an air atmosphere, or an inert gas atmosphere.

After a Na compound having a P2-type structure is synthesized, the Na compound may be pulverized using a mortar and pestle or a ball mill.

### 4.2 Ion Exchange

In the manufacturing method of the present disclosure, at least a portion of Na in the Na compound is replaced with Li by ion exchange, while allowing Na to remain in layer form, to obtain a Li compound having an O2-type structure. The ion exchange includes a method using an aqueous solution comprising a lithium halide and a method using a mixture (for example, a molten salt) of a lithium halide and an additional lithium salt. In some embodiments, the method using a molten salt, of the above two methods, is used from the viewpoint that a P2-type structure is fragile due to intrusion of water and from the viewpoint of crystallinity. Specifically, by mixing the above Na compound having a P2-type structure and the molten salt and heating to a temperature above or equal to the melting point of the molten salt, at least a portion of Na in the Na compound can be replaced with Li by ion exchange.

In some embodiments, the lithium halide constituting the molten salt is at least one of lithium chloride, lithium bromide, and lithium iodide. In some embodiments, the additional lithium salt constituting the molten salt is lithium nitrate. By using a molten salt, since the melting point is lower than that of the lithium halide or the additional lithium salt when used alone, the ion exchange can be carried out at a lower temperature.

The temperature of the ion exchange may be, for example, 600° C. or lower, 500° C. or lower, or 400° C. or lower. When the temperature of the ion exchange is too high, an O3-type structure, which is a stable phase, is likely to be generated instead of an O2-type structure. On the other hand, from the viewpoint of shortening the time required for the ion exchange, the temperature of the ion exchange may be as high as possible.

### 4.3 Example of Conditions for Allowing Na to Remain in Layer Form

According to the findings of the present inventor, when a Li compound having an O2-type structure is obtained from a Na compound having a P2-type structure by ion exchange, it is effective, for example, to form a structure belonging to space group P-6m2 as an intermediate during ion exchange in order for Na to remain in layer form. To achieve this, for example, in some embodiments a compound having a predetermined composition is adopted as the Na compound having a P2-type structure. Specifically, the Na compound before ion exchange may have a composition represented by Na_{c}Mnₓ₋ₚNi_{y-q}Co_{z-r}M_{p+q+r}O₂, wherein 0.70≤c≤1.00; x+y+z=1; 0<p+q+r≤0.15; and M is at least one element selected from B, Mg, Al, K, Ca, Ti, V, Cr, Fe, Cu, Zn, Ga, Ge, Sr, Y, Zr, Nb, Mo, and W. In addition, when the valence of M in the P2-type structure is +n, a relation of 3.0≤4(x−p)+2(y−q)+3(z−r)+n(p+q+r)≤3.4 may be satisfied.

A P2-type structure is easily maintained in the Na compound when “c” of the above chemical composition is 1.00 or less. In addition, when the Na composition exceeds the stoichiometric composition Na_{2/3}, a crystal structure belonging to space group P-6m2 is likely to be formed. When Na is replaced with Li by ion exchange, the crystal structure belonging to space group P-6m2 is stabilized if a superlattice structure having a Na-to-Li ratio of 1:1 is formed. However, when the amount of Na in the P2-type structure is small, the nucleation of an O2-type structure is faster than the formation of the crystal structure belonging to space group P-6m2, and the O2-type structure is easily formed without going through a crystal structure belonging to space group P-6m2. On the other hand, when the amount of Na in the P2-type structure is large, the nucleation of an O2-type structure takes time, Li and Na sufficiently diffuse, and as a result, a crystal structure belonging to space group P-6m2 is easily formed. From such a viewpoint, in some embodiments, “c” of the above chemical composition is 0.70 or greater, and may be greater than 0.70, 0.71 or greater, or 0.72 or greater. The x, y, z, p, q, and r are as described above.

According to the findings of the present inventor, when a Li compound having an O2-type structure is obtained from a Na compound having a P2-type structure by ion exchange, it is effective to adopt a method in which nucleation rate during ion exchange is high, i.e., a method with a fast ion exchange reaction, in addition to using a compound having the above chemical composition as the Na compound, in order for Na to remain in layer form. Specifically, in some embodiments, at least one of the following conditions (1) to (3) be satisfied.
(1) The temperature of the ion exchange is 350° C. or higher.
(2) In the ion exchange, a mixture (for example, the above molten salt) of a lithium halide (A) and a lithium compound (B) other than a lithium halide is used, and a mass ratio (A/B) of the lithium halide (A) to the lithium compound (B) of the mixture is 0.25 or greater.
(3) In the ion exchange, a lithium halide having a high reduction power, i.e., at least one of LiBr and LiI is used.

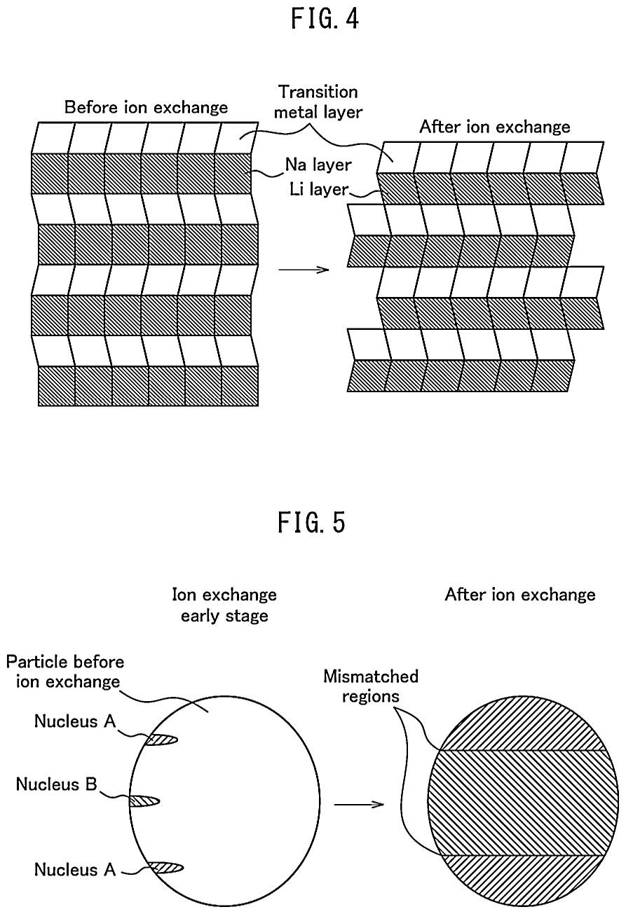

FIG. 4 schematically shows lattice shift before and after ion exchange. FIG. 5 shows that a large number of nuclei are generated during ion exchange, and these nuclei grow to form mismatched regions on boundary surfaces. Normally, stacking faults are formed at these sites. However, when a composition region where a P2*-type structure is formed as an intermediate structure is selected, it is considered that Na remains in a mismatched region and forms a P2*-like structure, thereby alleviating the mismatch. From the above mechanism, as in the manufacturing method of the present disclosure, by using a compound having the above chemical composition as the Na compound and adopting a method in which the nucleation rate during ion exchange is high, i.e., a method with a fast ion exchange reaction, it is considered that Na is likely to remain in a mismatched region. That is, Na is likely to remain in layer form in the finally obtained positive electrode active material.

### EXAMPLES

Hereinafter, the technique of the present disclosure will be further described in detail with reference to the Examples. However, the technique of the present disclosure is not limited to the following examples.

### 1. Example 1

### 1.1 Synthesis of Na Compound Having P2-Type Structure

Mn(NO₃)₂·6H₂O, Ni(NO₃)₂·6H₂O, and Co(NO₃)₂·6H₂O as raw materials were dissolved in pure water so that the molar ratio of Mn, Ni, and Co was 5:2:3. Separately, a Na₂CO₃ solution having a concentration of 12% by weight was prepared. The two solutions were then dropped simultaneously into a beaker. In this case, the titration rate was controlled so that the pH was 7.0 or greater and less than 7.1. After titration was completed, the mixed solution was stirred for 24 h under the conditions of 50° C. and 300 rpm. The resulting reaction product was washed with pure water and separated by centrifugation to only a precipitate powder. The obtained powder was dried at 120° C. for 48 h and then pulverized with an agate mortar to obtain a powder. Na₂CO₃ was mixed with the resulting powder so that the composition ratio was Na_{0.85}Mn_{0.5}Ni_{0.2}Co_{0.3}O₂. The mixed powder was pressed with a load of 2 tons by a cold isostatic pressing method to prepare pellets. The resulting pellets were pre-fired under an air atmosphere at 600° C. for 6 h and then fired at 900° C. for 24 h to synthesize a Na compound having a P2-type structure.

### 1.2 Ion Exchange

LiNO₃ and LiCl were mixed at a mass ratio of 88:12 and weighed so that the molar ratio of the amount of Li to the Na compound having a P2-type structure was 10. The Na compound and the LiNO₃—LiCl mixed powder were mixed, and ion exchange was carried out at 350° C. for 1 h in an air atmosphere. After the ion exchange, water was added to dissolve excess salt, and the mixture was washed with water to obtain a Li compound (positive electrode active material) having an O2-type structure.

### 1.3 Production of Positive Electrode

In 125 mL of N-methylpyrrolidone solution in which 5 g of PVdF as a binder was dissolved, 85 g of the positive electrode active material obtained as described above and 10 g of carbon black as a conductive aid were uniformly kneaded to prepare a positive electrode mixture paste. The paste was applied at a basis weight of 6 mg/cm² to one side of an Al current collector having a thickness of 15 μm and dried to obtain a laminated body. The laminated body was then pressed to a paste thickness of 45 μm and a paste density of 2.4 g/cm³. Finally, the laminated body was cut to a size of 16 mm in diameter to obtain a positive electrode.

### 1.4 Production of Negative Electrode

A Li foil was cut to a size of 19 mm in diameter to obtain a negative electrode.

### 1.5 Production of Lithium-Ion Secondary Battery

The obtained positive and negative electrodes were used to produce a CR2032-type coin cell. Here, a PP porous separator was used as the separator, and a solution in which lithium hexafluorophosphate (LiPF₆) as a supporting salt was dissolved at a concentration of 1 mol/L in a mixture of EC (ethylene carbonate) and DMC (dimethyl carbonate) at a volume ratio of 3:7 was used as the electrolytic solution.

### 2. Example 2

Except that a blending ratio of LiNO₃ to LiCl during ion exchange was set to 70:30 and the ion exchange temperature to 280° C., a positive electrode active material was obtained in the same manner as in Example 1 to produce a lithium-ion secondary battery.

### 3. Comparative Example 1

Except that the charging composition for obtaining the Na compound was set to Na_{0.75}Mn_{0.5}Ni_{0.2}Co_{0.3}O₂, a positive electrode active material was obtained in the same manner as in Example 1 to produce a lithium-ion secondary battery.

### 4. Comparative Example 2

Except that the ion exchange temperature was set to 280° C., a positive electrode active material was obtained in the same manner as in Example 1 to produce a lithium-ion secondary battery.

### 5. Evaluation

### 5.1 Identification of Crystalline Phase by XRD

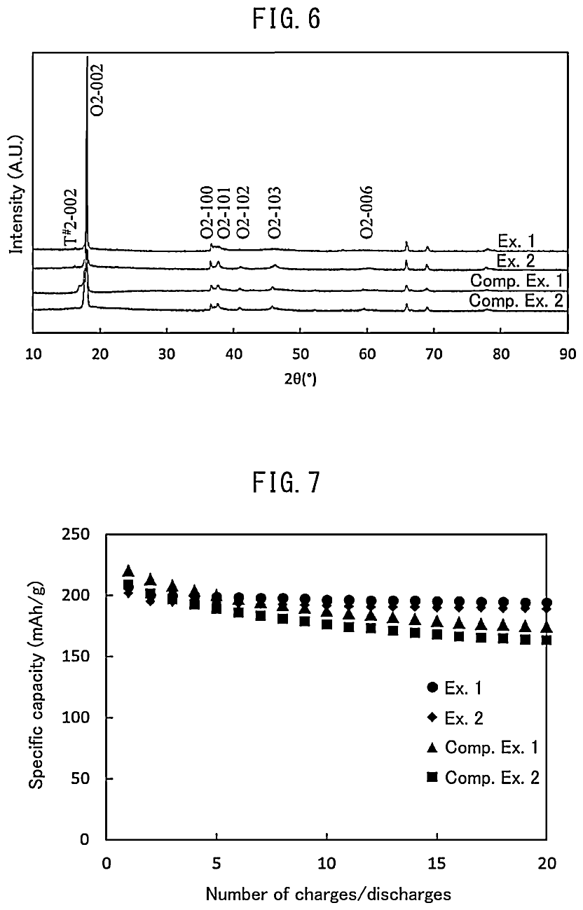

Crystal phases of each of the positive electrode active materials obtained in Examples 1 and 2 and Comparative Examples 1 and 2 were identified by powder X-ray diffraction. The results are shown in FIG. 6. As shown in FIG. 6, all of the positive electrode active materials had an O2-type structure (and any derivative structures thereof).

### 5.2 Identification of Composition by ICP-AES

ICP-AES measurements were carried out for each of the Na compound and the Li compound (positive electrode active material) in Examples 1 and 2 and Comparative Examples 1 and 2. The results are shown in Table 1 below. Note that, the compositions shown in Table 1 below are normalized so that the sum of transition metal compositions is 1.00. As shown in Table 1, it was found that the Na composition of the Na compound in each of Examples 1 and 2 was 0.70 or greater, while the Na composition of the Na compound in each of Comparative Examples 1 and 2 was less than 0.70. Further, it was found that the Na composition of the Li compound in each of Examples 1 and 2 was 0.05 or greater, while the Na composition of the Li compound in each of Comparative Examples 1 and 2 was less than 0.05.

TABLE 1

| | | Li | Na | Mn | Ni | Co |
|---|---|---|---|---|---|---|
| Example 1 | Na compound | 0.00 | 0.76 | 0.50 | 0.20 | 0.30 |
| | Li compound | 0.69 | 0.08 | 0.50 | 0.20 | 0.30 |
| Example 2 | Na compound | 0.00 | 0.72 | 0.50 | 0.20 | 0.30 |
| | Li compound | 0.66 | 0.06 | 0.50 | 0.20 | 0.30 |
| Comparative | Na compound | 0.00 | 0.66 | 0.50 | 0.20 | 0.30 |
| Example 1 | Li compound | 0.67 | 0.00 | 0.50 | 0.20 | 0.30 |
| Comparative | Na compound | 0.00 | 0.69 | 0.50 | 0.20 | 0.30 |
| Example 2 | Li compound | 0.66 | 0.02 | 0.50 | 0.20 | 0.30 |

### 5.3 Evaluation of Cycle Stability

Each of the lithium-ion secondary batteries produced in Examples 1 and 2 and Comparative Example 1 was repeatedly charged and discharged, and cycle stability was evaluated. In a charge/discharge test, a battery was charged to 4.8 V and discharged to 2.0 V under the condition of 0.1 C for each. The results are shown in FIG. 7. As shown in FIG. 7, it was found that the lithium-ion secondary batteries according to Examples 1 and 2, in which the Na composition of the positive electrode active material was 0.05 or greater, each have a smaller capacity degradation during charge/discharge cycles and cycle stability, compared to the lithium-ion secondary batteries according to Comparative Examples 1 and 2.

### 5.4 Evaluation by HAADF-STEM and STEM-EDXS

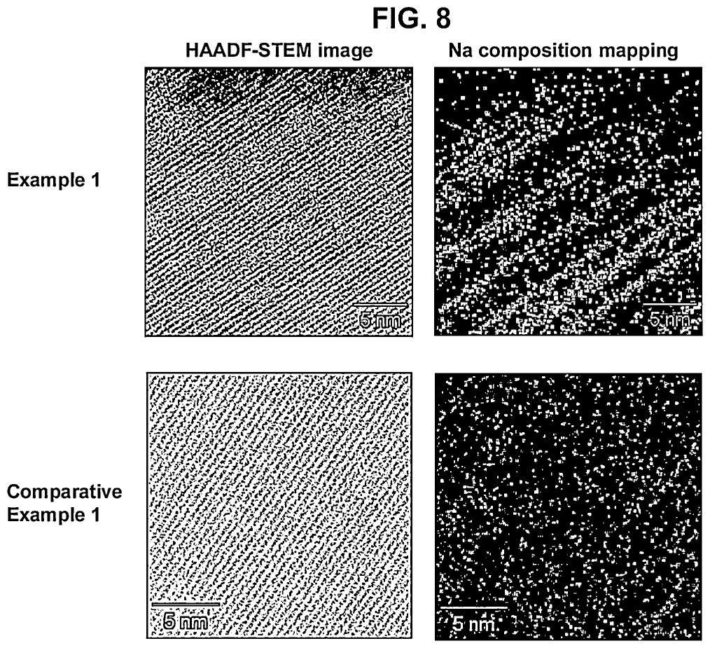

Each of the Li compounds in Example 1 and Comparative Example 2 was observed with HAADF-STEM and STEM-EDXS. FIG. 8 shows a HAADF-STEM image of a surface of each of the positive electrode active materials according to Example 1 and Comparative Example 2 and a Na composition mapping corresponding to each of the HAADF-STEM images. As shown in FIG. 8, it was found that Na was present in layer form in the Li compound according to Example 1, whereas Na was not present in layer form in the Li compound according to Comparative Example 2 and was dispersed throughout the compound. In Example 1, it is considered that the Na present in layer form in the Li compound functioned as a pinning phase and stabilized the crystal structure, and as a result, cycle stability was ensured.

### 6. Supplementary

Although the above description recites compounds having predetermined compositions as the positive electrode active material having an O2-type structure, the composition of the positive electrode active material is not limited thereto. The same effect can be obtained by including doping elements such as B, Mg, Al, K, Ca, Ti, V, Cr, Fe, Cu, Zn, Ga, Ge, Sr, Y, Zr, Nb, Mo, and W in the positive electrode active material.

### REFERENCE SIGNS LIST

10 positive electrode
   11 positive electrode active material layer
   12 positive electrode current collector
20 electrolyte layer
30 negative electrode
   31 negative electrode active material layer
   32 negative electrode current collector
100 secondary battery

1. A positive electrode active material having an O2-type structure, wherein
the positive electrode active material includes at least Li, Na, at least one of Mn, Ni, and Co, and O as constituent elements, and
the positive electrode active material has Na present in layer form.

2. The positive electrode active material according to claim 1, wherein
the positive electrode active material has a composition represented by LiₐNa_{b}Mnₓ₋ₚNi_{y-q}Co_{z-r}M_{p+q+r}O₂, wherein 0<a≤1.00; 0.05≤b≤0.20; x+y+z=1; 0≤p+q+r≤0.15; and
M is at least one element selected from B, Mg, Al, K, Ca, Ti, V, Cr, Fe, Cu, Zn, Ga, Ge, Sr, Y, Zr, Nb, Mo, and W.

3. A lithium-ion secondary battery, comprising a positive electrode, an electrolyte layer, and a negative electrode, wherein
the positive electrode comprises the positive electrode active material according to claim 1.

4. A manufacturing method for a positive electrode active material, the method comprising:
obtaining a Na compound having a P2-type structure, and
replacing a portion of Na in the Na compound with Li by ion exchange, while allowing Na to remain in layer form, to obtain a Li compound having an O2-type structure.

5. The manufacturing method according to claim 4, wherein
the Na compound has a composition represented by Na_{c}Mnₓ₋ₚNi_{y-q}Co_{z-r}M_{p+q+r}O₂, wherein 0.70≤c≤1.00; x+y+z=1; 0<p+q+r≤0.15; and M is at least one element selected from B, Mg, Al, K, Ca, Ti, V, Cr, Fe, Cu, Zn, Ga, Ge, Sr, Y, Zr, Nb, Mo, and W, and
in the ion exchange, at least one of the following conditions (1) to (3) is satisfied:
(1) a temperature of the ion exchange is 350° C. or higher;
(2) a mixture of a lithium halide (A) and a lithium compound (B) other than a lithium halide is used in the ion exchange, and a mass ratio (A/B) of the lithium halide (A) to the lithium compound (B) of the mixture is 0.25 or greater; and
(3) at least one of LiBr and LiI is used in the ion exchange.
